(19) United States
(12) Patent Application Publication
(10) Pub. No.: US 2002/0154014 A1
(43) Pub. Date: Oct. 24, 2002

(54) One piece snap close anti-theft hang tag for merchandise

(76) Inventor: Steve Elston, Ormond Beach, FL (US)

Correspondence Address: Allen, Dyer, Doppelt, Milbrath & Gilchrist, P.A., P.O. Box 3791, 255 South Orange Avenue, Suite 1401, Orlando, FL, 32802-3791, US

(21) Appl. No.: 10/124,618

(22) Filed: Apr. 17, 2002

Related U.S. Application Data
(60) Provisional application No. 60/285,575, filed on Apr. 20, 2001.

(51) Int. Cl. G08B 13/14

(52) U.S. Cl. 340/572.8

(57) ABSTRACT

A hang tag having a bifolding body, one part of which has a long tail, and one of the parts having a recess adapted to receive an electronic article surveillance (EAS) device. The EAS device is placed or secured in the recess, the tail is wrapped around a piece of merchandise, and the other end of the tail is affixed to one of the bifolding bodies, and then the bifold is snapped shut permanently. The tag is made out of tough, minimal stretch plastic such as nylon or another polyamide, enabling the tag to be assembled onto the merchandise simply by looping and snapping, without any riveting or other joining required. Using a tough polymer, the snap fit can be designed to create a permanent attachment so that the tag would have to be cut off or destroyed to remove it.

### FIELD OF INVENTION

This invention relates generally, to fastener assemblies and more particular to a hang tag for housing and EAS device that is especially adapted to be attached to merchandise having a portion around which a tail or lead can be wrapped.

### BACKGROUND

Antitheft tags for consumer articles are well known, and systems using such devices are referred to as electronic article surveillance (EAS) systems. Exemplary of EAS devices and systems using the same are U.S. Pat. Nos. 5,949,336 and 5,955,951, and the reference cited there. In one embodiment, EAS tags have a circuit having a known resonant frequency and inducible to resonate by an externally applied magnetic or RF field, the existence of the expected resonance being evidence of the article: hence, placing such a device at the exit of an establishment indicates that an article of merchandise with such a tag is being taken from the store.

EAS devices and systems are well known. One aspect that retailers and manufacturers find is important is to keep the EAS tag as small and unobtrusive as possible. For example, a consumer looking at an article of clothing is less likely to purchase the article if it cannot be tried on because of the EAS tag, or because the article is fairly light (such as a shirt) but the EAS tag is oversized and too heavy to allow trying on the clothing article. As another example, attaching a conventional EAS tag to sunglasses, depending where on the spectacle frame the EAS tag is attached, typically renders the glasses almost impossible to wear, and thus a consumer is less likely to make the purchase because the article cannot be assessed properly or easily. Thus, for example, the above-noted U.S. Pat. No. 5,955,951 describes a relatively large EAS tag that is secured with a tack through clothing, and the U.S. Pat. No. 5,949,336 patent describes a less obtrusive device but one which looks like plastic tag of some sort. Yet another problem is that potential shoplifters may attempt to remove from the merchandise an EAS tag, or any tag (including, for example, a price tag) that is easily identifiable as such.

Various styles of hang tags have been developed over the years. One style is made of molded plastic body having a tab molded to the body as a one-piece unit, and where the body has a peg or similar device on which the tab can be secured after having been looped around the article to be sold. For large stores providing paper price or hang tags, a plastic loop having a flange or bulb at one end and a threadable eye at the other is known, where the bulb can be passed through and snap into the threadable eye, but cannot be pulled out without destroying the device. For the latter device, the plastic material used is a non-elastic, tough plastic, such as nylon. Nevertheless, in light of the existing devices, a simple hang tag housing an EAS device that can be permanently attached to an article is yet desired.

### SUMMARY OF THE INVENTION

One object of the invention is to provide a one piece hang tag that can house an EAS device and be attached easily to an article of merchandise.

Another object of the invention is to provide a hang tag housing an EAS device wherein the hang tag can be securely closed by mechanical means; that is, without the use of heat sealing or adhesive.

It is a further object of the invention to provide such a device having a integral method for being attached to an article of merchandise.

These and other objects of the invention are provided by a device comprising a body able to be folded onto itself, the body having dual inner portions having a recess therein adapted to receive an EAS device, one of the dual inner portions having a peg with a bulbous end and the other of the dual inner portions having a bore adapted to be snap-engaged by the bulbous end of the peg, the bore disposed in a second recess that extends to the margin of the inner portion, and a tail having two ends, one of which is attached to the body and the other of which has a loop adapted to permit the bulbous end of the peg to pass therethrough and having a size adapted to fit into said second recess.

### BRIEF DESCRIPTION OF THE DRAWINGS

A preferred embodiment of the invention and alternate embodiments are described by way of example with reference to the accompanying drawings in which:

FIGS. 1 and 2 are perspective views of alternative merchandize illustrating use of an embodiment of its present invention, by way of example;

FIG. 3 is a plan view of the housing of the tag according to this invention;

FIG. 4 is a side view of the tag with the tail held securely and an EAS device in the internal recess;

FIG. 5 is a side view of another embodiment analogous to that shown in FIG. 4; and

FIG. 6 is an idealized plan comparison view of the peg and accepting bore wherein they are not of the same geometry.

### DETAILED DESCRIPTION OF SPECIFIC EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

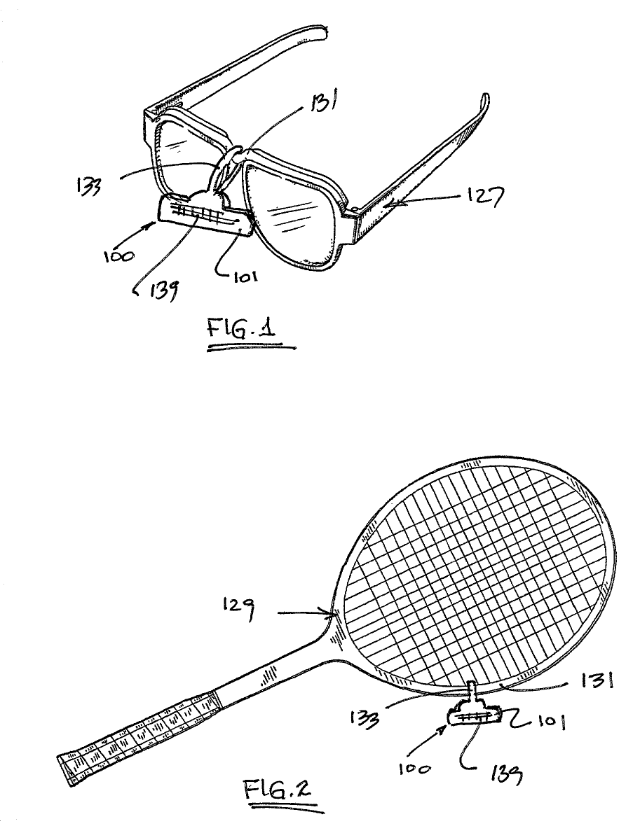

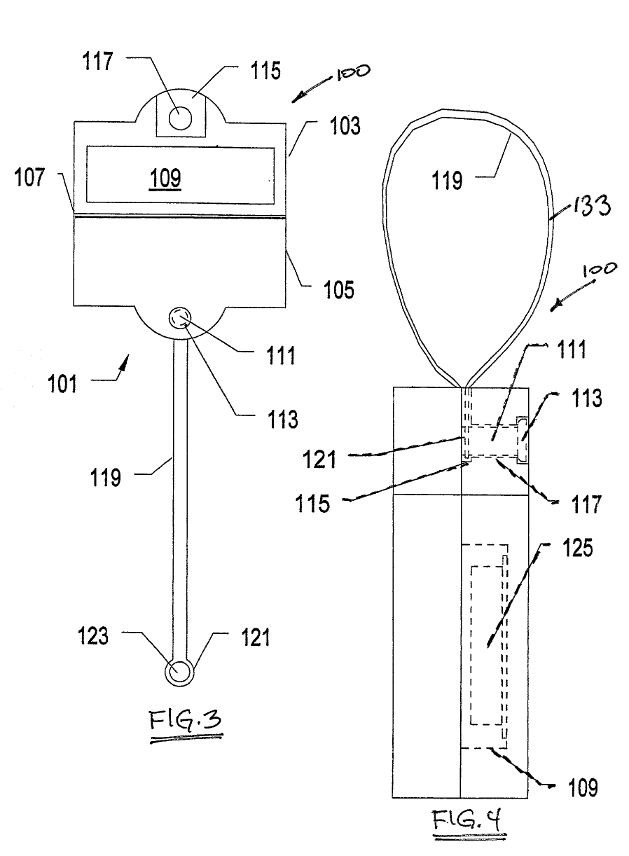

The device 100 is generally shown in FIGS. 1 and 2, and more particularly in FIG. 3 in which the body 101 has dual inner portions 103 and 105 separated by a crease line that functions as a hinge 107 allowing the body to be folded and the dual inner portions to face each other.

In one 103 of the dual inner portions is a peg 111 having a larger free and that is a flange 113 or is bulbous. On the other inner portion is a second recess 115 having a bore 117 that is sized to allow a snap-fit with the peg 111 and flange 113 of free end.

One of the portions of the body 101 is a tail 119 having a its free end a loop 121 with a bore 123 therein. The loop is sized to fit into the second recess 115, and the bore123 therein. The loop is sized to fit into the second recess 115, and the bore 123 is sized to fit over and receive the peg 111 and flange 113.

As illustrated again with reference to FIGS. 1 and 2, the device is very well adapted for use with eyeglasses, sunglasses, and the like, although it can be used with any merchandise having a portion 131 around which the tail 119 can be wrapped with sufficient play to allow the bore 123 in the loop 121 to fit over the peg 111. Thus, for example, the tail 119 can be put through a button eyelet in clothing, or around the frame portion 131 of a tennis racquet, the handle of a bottle or an appliance (such as an iron) or an accessory (such as a pocket book or briefcase).

In use, the EAS device 125 is secured into the first recess 109 the tail 119 is formed into a second loop 133 and the bore 123 in the loop 121 at the free end of the tail 119 is slipped over the flange 113 onto the peg 111. Thereafter, the body 101 is folded along the hinge (crease line) 107 and the flange 113 on the peg 111 is forced through the bore 117 in the second recess 115, to form the configurations shown in FIGS. 1,2 and 4.

The EAS device 125 is optionally secured by gluing or heat sealing. Alternatively, it need not be secured and can be merely placed in the first recess 109.

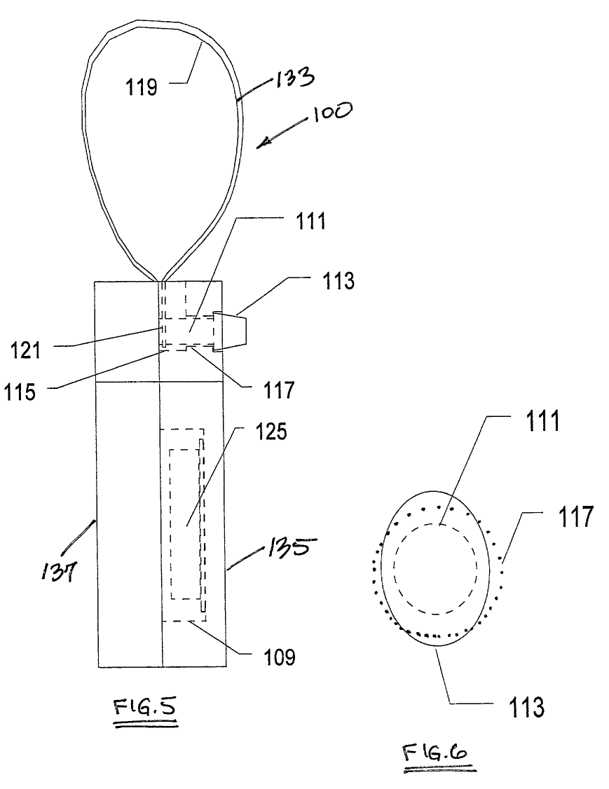

FIG. 5 is an alternative embodiment wherein the bulbous end 113 of the peg 111 extends above the level of the side 135, allowing the exposed end of the peg 111 to be contacted with a hot object to effect melting and heat sealing of the tag 100.

The other front exposed side 137 can serve as a substrate for a label, having a logo, barcode, price, and/or other information thereon. The other exposed side 129 may have such imprinted thereon, or it may be molded with raised and/or indented lettering having thereon, a logo, price, barcode, and/or other and/or similar information relating to the product. Of course, depending on the expense of the mold, either side 135 and/or 137 can serve as a substrate for a tag and/or have artwork 139 or information molded therein.

The anti-theft nature of the snap-fit tag device can be enhanced as shown in FIG. 6. The geometry of the bore 117 is shown dotted. Overlaid thereon is the geometry of the flange 113 and the peg 111. In this embodiment, the bore 117 is essentially circular, but the peg 111 and the flange 113 are essentially elliptical with the major axis, and preferably the minor axis, larger than the bore diameter. When the flange 113 is forced through the bore 117, especially with a tough plastic like nylon that is resistant to deformation, the snap-fit of the peg 111 within the bore 117 cannot be undone because the plastic cannot deform sufficiently to permit the tag 100 to be opened and removed from the merchandise, 127, 129.

The device 100 is preferably made of a tough plastic with low elasticity and deformity, which prevents the device 100 from being opened after it has been snapped closed. Accordingly, preferred materials of construction include nylon and other polyamides, polystyrene and other vinyl polymers, polybutylene and the like. Accordingly it is most preferred that the body 101 and tail 119 be integrally molded as a single piece. Of course, various colorants, fillers, mold release agents, and the like as are conventionally used can be added to the composition.

The foregoing description is meant to be illustrative and not limiting. Various changes, modifications, and additions may become apparent to the skilled artisan upon a perusal of this specification, and such are meant to be within the scope and spirit of the invention as defined by the claims.

What is claimed is:

1. A hang tag comprising:
a body foldable onto itself, the body having dual inner portions that meet when the body is folded onto itself, one of the dual inner portions having a recess therein adapted to receive an EAS device, one of the dual inner portions having a peg with a bulbous end and the other of the dual inner portions having a bore adapted to be snap-engaged by the bulbous end of the peg, the bore disposed in a second recess that extends to a margin of the inner portion; and
a tail having two ends, one of which is attached to the body and the other of which has a loop adapted to permit the bulbous end of the peg to pass therethrough and having a size adapted to fit into the second recess when the body is folded onto itself, the tail adapted to be wrapped around a portion of an article of merchandise.

2. The hang tag of claim 1, wherein the body and tail are molded as a single piece.

3. The hang tag of claim 2, wherein the device is comprised of nylon.

4. The hang tag of claim 1, further comprising an EAS device carried in the recess.

5. The hang tag of claim 4, wherein the EAS device is secured in the recess by an adhesive.

6. The hang tag of claim 1, wherein each of the inner portions is a substrate for an outer portion, at least one of the outer portions having a label thereon a having molded therein or thereon information or artwork about the merchandise.

7. The hang tag of claim 1, wherein the bulbous end is out of round.

8. The hang tag of claim 7, wherein the diameter of the bulbous end is larger than the bore.

9. The hang tag of claim 7, wherein the peg is out of round.

10. The hang tag of claim 9, wherein the peg diameter is larger than the bore.

11. The hang tag of claim 7, wherein the tag is made of a molded plastic that is resistant to deformation.

12. A hang tag comprising:
a body foldable onto itself, the body having dual inner portions that meet when the body is folded onto itself, one of the dual inner portions having a peg and the other of the dual inner portions having a bore adapted to be snap-engaged by the peg, the bore disposed in a second recess that extends to a margin of the inner portion; and
a tail having two ends, one of which is attached to the body and the other of which has a loop adapted to permit the peg to pass therethrough and having a size adapted to fit into the second recess when the body is folded onto itself, the tail adapted to be wrapped around a portion of an article of merchandise.

13. The hang tag of claim 12, wherein one of the dual inner portions inlcudes a recess therein adapted to receive an EAS device.

14. The hang tag of claim 12, wherein the body and tail are molded as a single piece.

15. The hang tag of claim 12, further comprising an EAS device carried in the recess.

16. The hang tag of claim 12, wherein each of the inner portions is a substrate for an outer portion, at least one of the outer portions having a label thereon a having molded therein or thereon information or artwork about the merchandise.

17. A hang tag comprising:
a body foldable onto itself, the body having dual inner portions that meet when the body is folded onto itself, the dual inner portions adapted to receive an EAS device, one of the dual inner portions having a peg and the other of the dual inner portions having a bore for engaging the peg; and
a tail having one end attached to the body and an opposing end adapted to engage the peg for securing thereto when the body is folded onto itself, the tail adapted to be wrapped around a portion of an article of merchandise.

18. The hang tag of claim 17, further comprising an EAS device carried by the body.

19. The hang tag of claim 17, wherein each of the inner portions is a substrate for an outer portion, at least one of the outer portions having a label thereon a having molded therein or thereon information or artwork about the merchandise.

20. The hang tag of claim 17, wherein the dual inner portion form a recess for carrying an EAS device when the dual inner portions are folded upon themselves.
